(19) United States
(12) Patent Application Publication
(10) Pub. No.: US 2025/0119544 A1
(43) Pub. Date: Apr. 10, 2025

(54) METHOD AND APPARATUS FOR ENCAPSULATING DATA OF A PLURALITY OF PORTIONS OF IMAGES IN A MEDIA FILE

(71) Applicant: CANON KABUSHIKI KAISHA, Tokyo (JP)

(72) Inventors: Frédéric MAZE, LANGAN (FR); Hervé RUELLAN, RENNES (FR); Franck DENOUAL, SAINT DOMINEUC (FR)

(21) Appl. No.: 18/909,244

(22) Filed: Oct. 8, 2024

(30) Foreign Application Priority Data
Oct. 9, 2023 (EP) 23306743.8
Oct. 31, 2023 (GB) 2316689.5

(51) Int. Cl. H04N 19/119; H04N 19/174; H04N 19/30; H04N 19/70

(52) U.S. Cl. CPC H04N 19/119; H04N 19/174; H04N 19/30; H04N 19/70

(57) ABSTRACT

The present invention concerns a method of encapsulation of a partitioned image in an ISOBMFF based media file, the image being partitioned in rectangular image portions, the image portions being independently decodable, the method comprising the following steps: obtaining the partitioned image; generating an image item describing the partitioned image; storing each image portion data in a different extent of the image item; associating information with the image item, the information indicating that each extent of the image item is constrained to enclose data units of the image item that are extractable and independently decodable; and encapsulating the image item, the partitioned image.

This application claims the benefit under 35 U.S.C. § 119 (a)-(d) of European Patent Application No. 23306743.8, filed on Oct. 9, 2023, and entitled “Method and apparatus for encapsulating data of a plurality of portions of images in a media file” and of United Kingdom Patent Application No. 2316689.5, filed on Oct. 31, 2023, and entitled “Method and apparatus for encapsulating data of a plurality of portions of images in a media file”. The above cited patent applications are incorporated herein by reference in their entirety.

### FIELD OF THE INVENTION

The present disclosure concerns a method and a device for encapsulating data of multiple portions of images in a media file. It concerns more particularly a method of encapsulation allowing an efficient access to large still images and panning across such images.

### BACKGROUND OF INVENTION

Modern cameras enable to generate very large still images of which only a spatial area may need to be displayed on a given display size (e.g. a smartphone device or an HD or 4K display), either to avoid downloading the complete image before displaying content or for panning across the images.

Images captured by a camera are stored on a storage device like a memory card, for example. The images are typically either encoded to reduce the size of data on the storage device or the pixels of the images are arranged according to an uncompressed image format (RGB or YUV formats are typical examples of such uncompressed image formats). Many encoding standards may be used, like JPEG, AOMedia Video 1 (AV1), High Efficiency Video Coding (HEVC) or the more recent Versatile Video Coding (VVC) standard. Such uncompressed or encoded image formats allow partitioning an image or picture into image or picture portions e.g. subpictures, slices, or tiles. A subpicture, a slice or a tile may represent a rectangular region of the image or picture.

The International Standard Organization Base Media File Format (ISOBMFF, ISO/IEC 14496-12) is a well-known flexible and extensible format that describes the encapsulation of timed or untimed media data or bit-streams either for local storage or transmission via a network or via another bit-stream delivery mechanism. An ISO Base media file is object-oriented and structured into “boxes” that are sequentially or hierarchically organized. Boxes are data structures provided to describe the data in the files. Boxes (also denoted objects, atoms, structure-data, or data structures) are building blocks defined by a unique type identifier (typically a four-character code, also noted FourCC or 4CC) and a length. All data in a file (media data and metadata describing the media data) is contained in boxes. There is no other data within the file. File-level boxes are boxes that are not contained in other boxes.

This file format has several extensions developed by the Moving Picture Experts Group (MPEG), for instance:
HEIF (for High Efficiency Image File Format or Image File Format-ISO/IEC 23008-12) is a generic standard for storage and sharing of images and image sequences, as well as their associated metadata. It also specify the format for encapsulating coded images or image sequences with the coding format JPEG, HEVC or VVC for instance.
MIAF (for Multi-Image Application Format-ISO/IEC 23000-22) is a standard specifying a multimedia application format which enables precise interoperability points for the creation, reading, parsing and decoding of images embedded in the HEIF format. The MIAF specification fully conforms to the HEIF format and only defines additional constraints to ensure higher interoperability.
Carriage of uncompressed video and images in ISO Base Media File Format (ISO/IEC 23001-17) is a standard specifying how uncompressed 2D image and video data is carried in files in the family of standards based on the ISO base media file format (ISO/IEC 14496-12).

While these file formats provide the ability to store, access and exchange coded and uncompressed images or image sequences, there is a continuous need to improve the storage of data and the description of this data allowing an efficient access to portions of images or image sequences, in particular to improve the storage and access to very large still images to avoid downloading the complete image before displaying content or for panning across the images.

### SUMMARY OF THE INVENTION

The present invention has been devised to address one or more of the foregoing concerns.

According to a first aspect of the invention there is provided a method of a method of encapsulation of a partitioned image in an ISOBMFF based media file, the image being partitioned in rectangular image portions, the image portions being independently decodable, the method comprising the following steps:
obtaining the partitioned image;
generating an image item describing the partitioned image;
storing each image portion data in a different extent of the image item;
associating information with the image item, the information indicating that each extent of the image item is constrained to enclose data units of the image item that are extractable and independently decodable; and
encapsulating the image item, the associated information and the partitioned image.

In an embodiment, the information is a dedicated item property associated with the image item.

In an embodiment, the image portions are organized in a grid in raster scan order.

In an embodiment, all image portions having the same size, the size in pixels of an image portion may be determined from information described in a decoder configuration information box and/or from information in an item property associated with the image item.

In an embodiment, the information is stored in an ItemLocationBox of the media file.

In an embodiment, the information comprises optional parameters for describing properties of the image portions.

In an embodiment, the method further comprises:
generating a pyramid of partitioned overview images from the partitioned image, each partitioned overview image being a lower resolution version of the partitioned image;
encapsulating at least one of the partitioned overview images according to the method of claim 1;
generating an entityToGroup grouping the partitioned image and the overview images; and
encapsulating the entity ToGroup in the media file.

In an embodiment, all the partitioned overview images are encapsulated according to the invention.

In an embodiment, the information is stored in the entityToGroup.

According to another aspect of the invention there is provided a method of rendering an image portion of a partitioned image encapsulated in an ISOBMFF based media file, the method comprising:
obtaining from the media file an image item describing the partitioned image;
obtaining from the media file an information associated with the image item, the information indicating that each extent of the image item is constrained to enclose data units of the image item that are extractable and independently decodable;
selecting an extent of the image item;
extracting the image data portion enclosed in the extent and
rendering the image portion using the extracted image data portion.

In an embodiment, the information is obtained from a dedicated item property associated with the image item.

In an embodiment, the image portions are organized in a grid in raster scan order.

In an embodiment, all image portions having the same size, the size in pixels of an image portion may be determined from information described in a decoder configuration information box and/or from information in an item property associated with the image item in the media file.

In an embodiment, the information is obtained from an ItemLocationBox of the media file.

In an embodiment, the information comprises optional parameters for describing properties of the image portion.

In an embodiment, the method further comprises:
obtaining from the media file an entityToGroup grouping the partitioned image and partitioned overview images forming a pyramid of partitioned overview images, each partitioned overview image being a lower resolution version of the partitioned image;
rendering an image portion of a partitioned overview image according to the method of the invention.

According to another aspect of the invention there is provided a computer program product for a programmable apparatus, the computer program product comprising a sequence of instructions for implementing a method according to the invention, when loaded into and executed by the programmable apparatus.

According to another aspect of the invention there is provided a computer-readable storage medium storing instructions of a computer program for implementing a method according to the invention.

According to another aspect of the invention there is provided a computer program which upon execution causes the method of the invention to be performed.

According to another aspect of the invention there is provided a processing device comprising a processing unit configured for carrying out each step of the method according to the invention.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates an example of a media file 101 that contains media data like one or more still images and possibly one or more video and/or one or more sequences of images;

FIG. 2 illustrates some examples of storage of a partitioned still image or picture in an ISOBMFF-based media file allowing to describe and access data portions corresponding to each portion of the still image or picture;

FIG. 3 illustrates a storage of a partitioned still image or picture in an ISOBMFF-based media file allowing to describe and access data portions corresponding to each portion of the still image or picture according to some embodiments of the disclosure;

FIG. 4 illustrates a storage of multiple partitioned still image or picture in an ISOBMFF-based media file allowing to avoid downloading the complete image before displaying content or for panning across the images according to some embodiments of the disclosure;

FIG. 5 illustrates the main steps of a process for encapsulating partitioned images according to embodiments of the invention;

FIG. 6 illustrates the main steps of a process for parsing a media file comprising a partitioned image possibly encapsulated according to embodiments of the invention and rendering an image portion of the partitioned image;

FIG. 7 is a schematic block diagram of a computing device for implementation of one or more embodiments of the invention.

### DETAILED DESCRIPTION OF THE INVENTION

The JPEG, AOMedia Video 1 (AV1), High Efficiency Video Coding (HEVC) standards or the more recent Versatile Video Coding (VVC) standard define a profile for the encoding of still images (also denoted pictures) and describes specific tools for compressing single still images or sequences of still images, including the partitioning of such still images into image or picture portions e.g. subpictures, slices, or tiles. An extension of the ISO Base Media File Format (ISOBMFF) used for such kind of image data is described into the ISO/IEC 23008 standard, in Part 12, under the name: “HEIF” or “High Efficiency Image File Format” or “Image File Format”. In addition, a multimedia application format has been defined into the ISO/IEC 23000 standard, in Part 22, under the name “MIAF” or “Multi-Image Application Format” which enables precise interoperability points for the creation, reading, parsing and decoding of images embedded in the HEIF format.

The HEIF and MIAF standards cover two forms of storage corresponding to different use cases:
the storage of image sequences, which can be indicated to be displayed as a timed sequence or by other means, and in which the images may be dependent on other images, and
the storage of a single coded image or a collection of independently coded images, possibly with derived images.

In the first case, the encapsulation is close to the encapsulation of the video tracks in the ISO Base Media File Format (see document «<Information technology-Coding of audiovisual objects-Part 12: ISO base media file format>, w22955, ISO/IEC 14496-12, Eighth edition, September 2023), and similar tools and concepts are used, such as the ‘trak’ boxes and the sample grouping for description of groups of samples. The ‘trak’ box is a file format box that contains sub boxes for describing a track, that is to say, a timed sequence of related samples.

In the second case, a set of ISOBMFF boxes dedicated to the description of untimed data is used. These boxes are typically declared within the ‘meta’ box hierarchy and relate to “information items” or “items” instead of related samples in a video. It is to be noted that the wording ‘box’ and the wording ‘container’ may be both used with the same meaning to refer to data structures that contain metadata describing the organization or/and properties of an image and its data in the file.

Another extension of the ISO Base Media File Format (ISOBMFF) and of the Image File Format (HEIF) is also described into the ISO/IEC 23001 standard, in Part 17, for the carriage of uncompressed video and images, including but not limited to monochromatic data, colour data, transparency (alpha) information and depth information, and including the description of uncompressed image or picture organized as a set of one or more rectangular, non-overlapping and contiguous (without holes) areas called tiles.

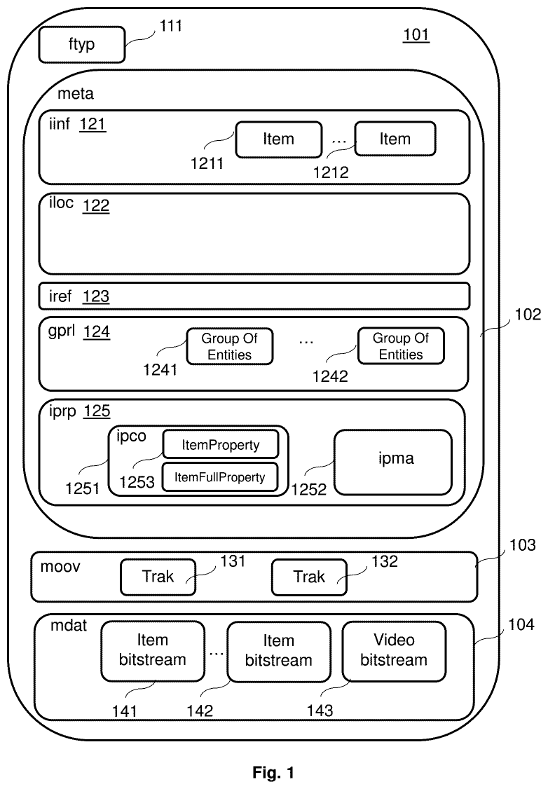

FIG. 1 illustrates an example of a media file 101 that contains media data like the data of one or more still images and possibly one or more video and/or one or more sequences of images. This file contains a first ‘ftyp’ box (FileTypeBox) 111 that contains an identifier of the type of file (typically a set of four character codes). This file contains a second box called ‘meta’ (MetaBox) 102 that is used to contain general untimed metadata including metadata structures describing the one or more still images. This ‘meta’ box 102 contains an ‘iinf’ box (ItemInfoBox) 121 that describes several single images or untimed objects (e.g. Exif or XMP metadata). Each single image or untimed object is described by a metadata structure ItemInfoEntry also denoted items 1211 and 1212. An item comprising image data is also denoted image items. An image item is an item whose data is a coded or uncompressed image or a derived image. A derived image is a representation of an image as an operation on other images (also denoted input images). Each item has a unique 16-bit or 32-bit identifier item_ID. The media data corresponding to these items is stored in the container for media data, the ‘mdat’ box 104. An ‘iloc’ box (ItemLocationBox) 122 provides, for each item (identified by item_ID) its item location information, comprising one or more pairs of offset (extent_offset) and length (extent_length) of its associated media data within the media file. Each pair of offset and length represents a contiguous byte range of data or media data and is called an ‘extent’. The size (in bytes) of an item is the sum of the extent lengths. Extents allow multiplexing byte ranges of media data among items. The ‘iloc’ box 122 also comprises for each item a construction_method field indicating the ‘contruction method’ for the item. This field may have following values:
0 (file_offset): indicates that extent offsets for the item are absolute byte offsets into the file (in such case the associated media data are stored in the ‘mdat’ box 104) or the payload of an ‘imda’ box (IdentifiedMediaDataBox, not represented) referenced by a data_reference_index field in the ‘iloc’ box 122.
1 (idat_offset): indicates that extent offsets for the item are byte offsets into an ItemDataBox ‘idat’ (not represented) in the same MetaBox ‘meta’ 102.
2 (item_offset): indicates that extent offsets for the item are byte offsets into another item indicated by the item_reference_index field in the ‘iloc’ box 122.

An ‘iloc’ box has the following syntax:

```
Box Type: ‘iloc’
Container: MetaBox
Mandatory: No
Quantity: Zero or one
aligned(8) class ItemLocationBox extends FullBox (‘iloc’,
version, 0)
{
  unsigned int(4) offset_size;
  unsigned int(4) length_size;
  unsigned int(4) base_offset_size;
  if ((version == 1) ∥ (version == 2)) {
    unsigned int(4) index_size;
  } else {
    unsigned int(4) reserved;
  }
  if (version < 2) {
    unsigned int(16) item_count;
  } else if (version == 2) {
    unsigned int(32) item_count;
  }
  for (i=0; i<item_count; i++) {
    if (version < 2) {
      unsigned int(16) item_ID;
    } else if (version == 2) {
      unsigned int(32) item_ID;
    }
    if ((version == 1) ∥ (version == 2)) {
      unsigned int(12) reserved = 0;
      unsigned int(4) construction_method;
    }
    unsigned int(16) data_reference_index;
    unsigned int(base_offset_size*8) base_offset;
    unsigned int(16) extent_count;
    for (j=0; j<extent_count; j++) {
      if (((version == 1) ∥ (version == 2)) &&
(index_size > 0)) {
        unsigned int(index_size*8)
item_reference_index;
      }
      unsigned int(offset_size*8) extent_offset;
      unsigned int(length_size*8) extent_length;
    }
  }
}
```

where
offset_size is taken from the set {0, 4, 8} and indicates the length in bytes of the offset field.
length_size is taken from the set {0, 4, 8} and indicates the length in bytes of the length field.
base_offset_size is taken from the set {0, 4, 8} and indicates the length in bytes of the base_offset field.
index_size is taken from the set {0, 4, 8} and indicates the length in bytes of the item_reference_index field.
item_count counts the number of resources in the following array.
item_ID is an arbitrary integer ‘name’ for this resource which can be used to refer to it (e.g. in a URL).
construction_method is taken from the set 0 (file), 1 (idat) or 2 (item) data_reference_index is either zero (‘this file’) or an index, with value 1 indicating the first entry, into the data references in a DataInformationBox ‘dinf’.
base_offset provides a base value for offset calculations within the referenced data. If base_offset_size is 0, base_offset takes the value 0, i.e. it is unused.
extent_count provides the count of the number of extents into which the resource is fragmented; it shall have the value 1 or greater.
item_reference_index provides an index as defined for the construction method extent_offset provides the absolute offset, in bytes from the data origin of the container, of this extent data. If offset_size is 0, extent_offset takes the value 0 extent_length provides the absolute length in bytes of this metadata item extent. If length_size is 0, extent_length takes the value 0.

An ‘iref’ box (ItemReferenceBox) 123 may also be defined to describe the association of one item with other items via typed references.

Optionally, for describing the storage of image sequences or video, the media file 101 may contain a third box called ‘moov’ (MovieBox) 103 that describes one or more image sequences or video tracks 131 and 132. Typically, the track 131 may be an image sequence (‘pict’) track designed to describe a set of images for which the temporal information is not necessarily meaningful and 132 may be a video (‘vide’) track designed to describe video content. Both tracks describe a series of image samples, an image sample being a set of pixels captured at the same time, for example a frame of a video sequence. The main difference between the two tracks is that in ‘pict’ tracks the timing information is not necessarily meaningful whereas for ‘vide’ tracks the timing information is intended to constraint the timing of the display of the samples. The data corresponding to these samples is stored in the container for media data, the ‘mdat’ box (MediaDataBox) 104 or in a ‘imda’ box (IdentifiedMediaDataBox, not represented).

The ‘mdat’ container 104 stores the data (e.g. data or bitstream of a coded or uncompressed image, Exif metadata, etc. . . . ) corresponding to items as represented by the data portions 141 and 142 and the timed coded or uncompressed images corresponding to samples as represented by the data portion 143.

A media file 101 offers different alternatives to store multiple images. For instance, it may store the multiple images either as items or as a track of samples that can be a ‘pict’ track or a ‘vide’ track. The actual choice is typically made by the application or device generating the file according to the type of images and the contemplated usage of the file.

Several alternatives can be used to group samples or items depending on the container that holds the samples or items to group. These alternatives can be considered as grouping data structures or grouping mechanism, i.e., boxes or data structures providing metadata describing a grouping criterion and/or group properties and/or group entities.

A first grouping mechanism represented by an EntityToGroupBox is adapted for the grouping of items or tracks. In this mechanism, the wording ‘entity’ is used to refer to items or tracks or other EntityToGroupBoxes. This mechanism specifies the grouping of entities. An EntityToGroupBox comprises a grouping_type, a group_id and a list of entity_ids.

The grouping_type is used to specify the type of the group. The group_id provides an identifier for the group of entities. The entity_id represents the identifier of entities that compose the group, i.e., either a track_ID for a track, an item_ID for an item or another group_id for an entity group. In FIG. 1, the groups of entities inheriting from the EntityToGroup box 1241 and 1242 are comprised in the container 124 identified by the four characters code ‘gprl’ for GroupsListBox.

Entity grouping consists in associating a grouping type which identifies the reason of the grouping of a set of items, tracks or other entity groups. In this document, it is referred to Grouping Information as information in one of the EntityToGroup Boxes which convey information to group a set of images.

Properties may be associated with items. These properties are called item properties and derived from a data structure ItemProperty or ItemFullProperty characterised by a 4CC also denoted property_type. The ItemPropertiesBox ‘iprp’ 125 enables the association of any item with an ordered set of item properties. The ItemPropertiesBox consists of two parts: an item property container box ‘ipco’ 1251 that contains an implicitly indexed list of item properties 1253, and an item property association box ‘ipma’ 1252 that contains one or more entries. Each entry in the item property association box associates an item with its item properties. When a specific brand ‘unif’ is defined in the media file, it indicates a unified handling of identifiers in the media file, for example across tracks, track groups, entity groups, and file-level MetaBoxes. When this brand is defined, it is possible to associate item properties with items and/or entity groups. Note that in the description, for genericity, we generally use item properties to designate both properties of an item or properties of an entity group. An item property associated with an entity group applies to the entity group as a whole and not individually to each entity within the group.

The ItemProperty and ItemFullProperty boxes are designed for the description of an item property. ItemFullProperty allows defining several versions of the syntax of the box and may contain one or more parameters whose presence is conditioned by either the version or the flags parameter.

The ItemPropertyContainerBox is designed for describing a set of item properties as an array of ItemProperty boxes or ItemFullProperty boxes.

The ItemPropertyAssociation box is designed to describe the association between items and/or entity groups and their item properties. It provides the description of a list of item identifiers and/or entity group identifiers, each identifier (item_ID) being associated with a list of item property index referring to an item property in the ItemPropertyContainerBox.

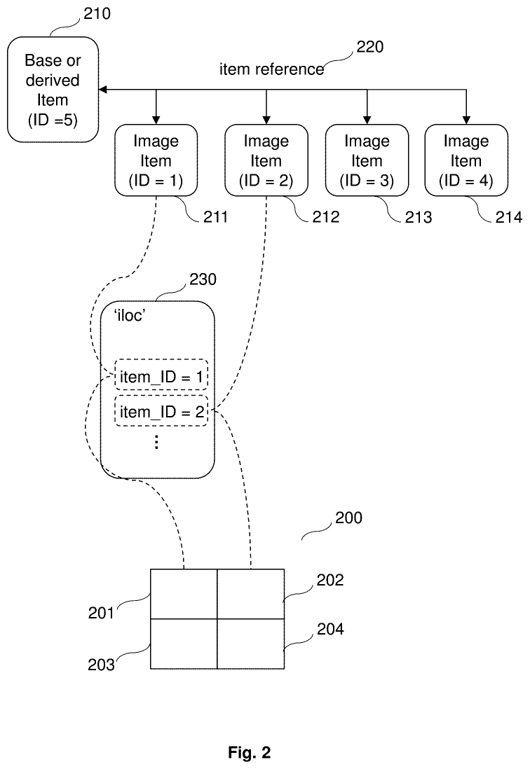

FIG. 2 illustrates some examples of storage of a partitioned still image or picture in an ISOBMFF-based media file allowing to describe and access data portions corresponding to each portion of the still image or picture.

An image 200 is partitioned into a plurality of image or picture portions, e.g., 201, 202, 203, 204.

When the image 200 is an uncompressed image, the image 200 may be spatially split in different rectangular images, or tiles, each resulting tile (e.g. 201, 202, 203, 204) being stored as an image item (respectively 211, 212, 213, 214) rather than storing the entire image data as a single item. Each image item is associated with the corresponding image data portion via the itemLocationBox ‘iloc’ 230 that associates a set of one or more extents with each item, each extent representing a contiguous byte-range of data. Tile layouts may be indicated using a grid derived image item 210. The grid derived image item 210 is a specific type of image item, called derived image item describing that the reconstructed image is formed from one or more input image items in a given grid order within a larger canvas. The input images are inserted in row-major order, top-row first, left to right, in the order of an item reference 220 of type ‘dimg’ from this derived image item to the input image items, the item reference being defined within the ItemReferenceBox ‘iref. The data (also denoted the body of the item) associated with the grid derived image item and located via the itemLocationBox ‘iloc’ 230 comprises the definition of the grid layout (e.g. the number of rows and columns and the size (output_width and output_height) of the reconstructed image.

Similar data organization and description can be used to carry an image 200 that is partitioned into image or picture portions or partitions before being encoded as a plurality of independent coded images.

Each image or picture portion, 201, 202, 203, 204, can be encoded as independent images, for instance according to an image coding format such as JPEG, AV1, HEVC or VVC, and stored as independent image items 211, 212, 213 and 214 (e.g. as a JPEG image item of type ‘jpeg’, an HEVC image item of type ‘hvc1’ or VVC image item of type ‘vvc1’).

Some coding formats integrate partitioning as part of the coding process. This results in a single coded image comprising “extractable” or “independently decodable” tiles, slices or subpictures that can be rendered without decoding the whole coded image, i.e. that are “independently renderable”.

For instance, in VVC, a VVC subpicture is a rectangular region of a VVC picture with one or more slices forming a rectangular array of pixels without holes and may be extracted and decoded without the presence of other VVC subpictures if the VVC subpicture boundaries are treated as picture boundaries in the inter prediction process (i.e., when the corresponding flag sps_subpic_treated_as_pic_flag [i] or the flag sps_independent_subpics_flag as specified in ISO/IEC 23090-3 is equal to 1). Each VVC subpicture, e.g. corresponding to image portions 201, 202, 203, 204, can be stored as a VVC subpicture item 211, 212, 213 and 214 (with item type equal to ‘vvc1’ or ‘vvs1’). Each VVC subpicture item is associated with the corresponding image data portion via the itemLocationBox ‘iloc’ 230. Those VVC subpicture items may be associated with a VVC base item 210 whose item data doesn't contain VCL NAL units. When they are associated with a base item, an item reference 220 of type ‘subp’ is defined from the VVC base item to the VVC subpictures. The VVC base item is associated with a VvcSubpicOrderProperty ‘spor’ that allows determining the decoding order of the VVC subpicture items.

Even if the above examples of storage of a partitioned still image or picture have proven to allow describing and accessing the image data portions of each image portion, they requires to define an item per image portion, plus item references, and a base or a derived item to associate them together. This represents a description cost that increases a lot when the number of image portions is increasing like for very large still images. Hence, there is a need to improve the storage of data and the description of this data for very large still images.

### Extent Configuration as an Item Property

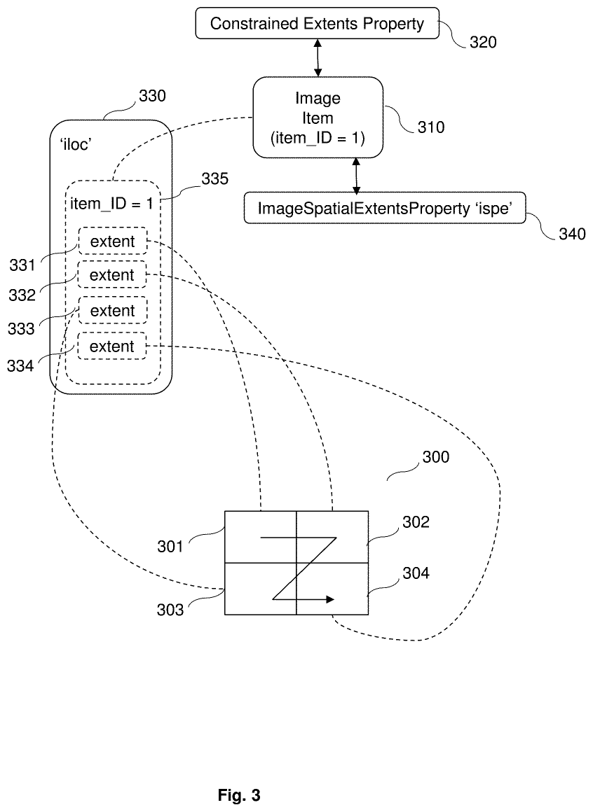

FIG. 3 illustrates a storage of a partitioned still image or picture in an ISOBMFF-based media file allowing to describe and access data portions corresponding to each portion of the still image or picture according to some embodiments of the disclosure.

An image 300 is partitioned into a plurality of image or picture portions, e.g., 301, 302, 303, 304. The partitioning may represent a regular grid or a non-regular grid of rectangular image portions or rectangular regions.

The image 300 may be uncompressed or encoded with a coding format supporting “extractable” or “independently decodable” regions or image portions or partitions, like for example tiles, slices or subpictures.

The image 300 is stored as a single image item 310 with an item type representing the coding or uncompressed format of the image 300, for instance ‘hvc1’ for an HEVC image, ‘vvc1’ for a VVC image or ‘unci’ for an uncompressed image. The image item 310 is associated with at least an ImageSpatialExtentsProperty ‘ispe’ 340 documenting the width and height of the reconstructed image in pixels. Depending on the coding format, the image item 310 may be also associated with a decoder configuration item property documenting the decoder configuration information, e.g., a UncompressedFrameConfigBox ‘uncC’ if the item type is ‘unci’, a VVC configuration item property ‘vvcC’ if the item type is ‘vvc1’, or a HEVC configuration item property ‘hvcC’ if the item type is ‘hvc1’.

The storage of the data of the image 300 is organized so each single extent 331, 332, 333, 334 in the item location information 335 corresponding to the image item 310 is constrained to include one single image data portion corresponding to image portions 301, 302, 303 and 304 respectively. Each extent of the associated image item in the itemLocationBox is constrained to enclose data units of the image item that are extractable (typically as a contiguous byte range) and independently decodable and renderable as an image tile or as a unit or decodable or renderable unit. In other words, each image data portion corresponding to image portions 301, 302, 303 and 304 is stored as one single extent, 331, 332, 333, 334 respectively. Each image data portion is stored as one extent to follow a raster scan order of the image portions within the image: i.e., the first extent corresponds to the top-left image portion and the last extent corresponds to the bottom-right image portion, going from left to right and top to bottom as illustrated on image 300 in FIG. 3.

This constraint on extents or configuration of extents is indicated to the player by associating an information, for example a dedicated item property, e.g. a ConstrainedExtentsProperty ‘cdex’ 320 (or any other name or 4CC not already used by the standard) with the image item 310. When this indication is not present, a player should not assume that the image data resides in the MediaDataBox or that extents are always used to split image data into smaller coding units, such as slices or tiles. Indeed, if not constrained, an image data portion corresponding to an image portion (e.g., slice, tile, subpicture or any other type of image portion) can be multiplexed with the image data portion of another image portion using multiple extents per image data portion.

Moreover, neither the construction_method or the extent_count field of the ItemLocationBox allow such indication.

The ConstrainedExtentsProperty may be defined as follows

```
  Box Type: ‘cdex’
  Property type: Descriptive item property
  Container: ItemPropertyContainerBox
  Mandatory (per item): No
  Quantity (per item): At most one
  aligned(8) class ConstrainedExtentsProperty extends
ItemFullProperty (‘cdex’, version = 0, flags = 0)
  {
  }
```

The ConstrainedExtentsProperty descriptive item property indicates that each extent in the itemLocationBox associated with the item is constrained to enclose data units of the item that are “extractable” or “independently decodable” as a unit. In a variant, each extent, except the first one, in the itemLocationBox associated with the item is constrained to enclose data units of the item that are “extractable” or “independently decodable” as a unit. In this variant, the first extent can be dedicated to store the non-VCL (xPS, SEIs . . . ) that are required to decode the data units of the other extents. In another variant, the non-VCL (xPS, SEIs . . . ) that are required to decode the data units of the extents are stored in another item or a dedicated item property associated with the image item 310. In any of above variants, ConstrainedExtentsProperty may comprises an indication (e.g. a specific “flags” value or a specific parameter) indicating where are located the non-VCL (xPS, SEIs . . . ) that are required to decode the data units of an extent. The image portions corresponding to the units represented by the extents are organized in a grid in raster scan order by default. In a particular embodiment, the regions are non-overlapping.

The size in pixels of an image portion corresponding to the unit represented by an extent may be determined from information described in a metadata box, for example a decoder configuration property or information box and/or in the ImageSpatialExtentsProperty ‘ispe’ associated with the item. For instance, for an uncompressed image, the UncompressedFrameConfigBox ‘uncC’ comprises parameters providing the number tile of columns and tile rows. num_tile_cols_minus_one plus one indicates the horizontal number of tiles in the frame and num_tile_rows_minus_one plus one indicates the vertical number of tiles in the frame. All tiles have the same width and height. The frame width (resp. height) is a multiple of num_tile_cols_minus_one+1 (resp. num_tile_rows_minus_one+1). The tile width is image_width/(num_tile_cols_minus_one+1), with image_width the frame width, and the tile height is image_height/(num_tile_rows_minus_one+1), with image_height the frame height, where image_width and image_height are documented in the ImageSpatialExtentsProperty ‘ispe’ associated with the item. With such information, a player can easily determine the coordinate of each tile relative to the full image and determine the index of the extent corresponding to the tile to render, for example, as follows:

$$grid\_cell \_x = floor ( x / tile\_width )$$

$$grid\_cell \_y = floor ( y / tile\_height )$$

$$extent\_index = ( ( num\_tile \_rows \_minus \_one + 1 ) ) ⋆ grid\_cell \_y + grid\_cell \_x$$

where
x,y represent the coordinates in pixels of the point identifying the current position on a display.
tile_width, tile_height represent the width and height in pixels of an image tile grid_cell_x, grid_cell_y represent the coordinate of the top left corner of an image tile in the grid of image tiles representing the full image, the grid being defined by num_tile_columns_minus_one+1 x num_tile_rows_minus_one+1.
extent_index is the index of the extent enclosing the data of the tile corresponding to the coordinates x,y. In an embodiment where tiles would overlap, there may be multiple extents corresponding to a same (x, y) coordinate.

Similarly, in another example, for a VVC image comprising VVC subpictures, the size in pixels of an image portion (subpicture) corresponding to the unit represented by an extent may be determined from information described in the VVC decoder configuration information box, for instance from information in a Sequence Parameter Set (SPS) listed in the VVC decoder configuration information box and comprising the parameters sps_subpic_width_minus1[i] and sps_subpic_height_minus1[i].

In some cases, it may not always be possible to obtain information describing the unit or image portion represented by an extent from the decoder configuration information box and the ImageSpatialExtentsProperty ‘ispe’ associated with the item. In such cases, it may be useful to provide this information directly with the ConstrainedExtentsProperty.

In variants, the ConstrainedExtentsProperty may comprise optional parameters for describing properties of the image data portion or the corresponding image portion that is stored in a constrained extent. Properties may include:
Information on the type of the image portion corresponding to the image data portion stored in an extent. This information can be codec-specific and depend on the type of the image item. For instance, the information may indicate if the image portion is a slice, a tile, a subpicture, a row of a picture or any region or image portion or partition that can be represented by a contiguous byte range.
Information on the scanning order of the image data portions stored in consecutive extents in an image, e.g. a grid. By default, the scanning order of the image data portions is in raster scan order (row by row from left to right), but different order may be specified in the ConstrainedExtentsProperty.
Information on the layout of the image portions relative to the full image (e.g., size (width and height) in pixels, e.g., in luma pixels, of a rectangular image portion, number of rows and columns, whether a grid is regular or not and if the grid is not regular, the size in pixels of each row and column), whether region may overlap or not, whether empty regions are present.

When several image items with constrained extents are grouped together in a grouping structure, e.g. in an entity group, then the ConstrainedExtentsProperty may be associated with the grouping structure, e.g. the entity group, to indicate that all the image items in the group have constrained extents as described by the ConstrainedExtentsProperty.

If the ConstrainedExtentsProperty comprises detailed information on a grid layout of the image portions or partitions, the data structure may also be named ConstrainedExtentsGridProperty.

In a variant, the ConstrainedExtentsProperty may be defined as follows

```
  Box Type: ‘cdex’
  Property type: Descriptive item property
  Container: ItemPropertyContainerBox
  Mandatory (per item): No
  Quantity (per item): At most one
  aligned(8) class ConstrainedExtentsProperty extends
ItemFullProperty (‘cdex’, version = 0, flags = 0)
  {
    unsigned int(32) codec_specific parameters;
  }
```

where
codec_specific_parameters is defined by the codec in use. If no such definition is available, this field may be set to 0 or may be omitted. For instance, it may specify whether the extent is constrained to enclose a slice, a tile or a subpicture. As another example, the 32-bit value may carry the width and height in pixels of a tile, each value being coded on 16 bits.

In another variant, the ConstrainedExtentsProperty may be renamed as ConstrainedExtentsGridProperty with a 4CC ‘cexg’ and defined as follows

```
  Box Type: ‘cexg’
  Property type: Descriptive item property
  Container: ItemPropertyContainerBox
  Mandatory (per item): No
  Quantity (per item): At most one
  aligned(8) class ConstrainedExtentsGridProperty extends
ItemFullProperty(‘cexg’, version = 0, flags)
  {
    if (flags & has_image_portion_size ==
has_image_portion_size) {
      unsigned int(32) image_portion_width;
      unsigned int(32) image_portion_height;
    }
    if (flags & has_scanning_order == has_scanning_order)
      unsigned int(8) scanning_order;
    if (flags & has_grid_layout == has_grid_layout) {
      unsigned int(16) rows_minus_one;
      unsigned int(16) columns_minus_one;
    }
    if (flags & has_codec_specific_parameters ==
has_codec_specific_parameters)
      unsigned int(32) codec_specific_parameters;
  }
```

where
flags indicates the properties that are defined in the box. Following flags value may be defined:
   has_image_portion_size=0x000001: indicates when set that the size of the image portion is present (for example as a width and a height in pixels).
   has_scanning_order=0x000002: indicates when set that the scanning order of the image portions is present. When not set, the scanning order is set to 0 and designates a scanning order of the image portions in a raster scan order.
   has_grid_layout=0x000004: indicates when set that the grid layout (number of rows and columns) is present. In a variant, if the grid is non-regular, the grid layout further provides the width of each column and the height of each row.
   has_codec_specific_parameters=0x000008: indicates when set that codec_specific_parameters field is present. When not set, codec_specific_parameters is may be set or inferred to 0.
image_portion_width and image_portion_height indicates the width and height of an image portion (e.g., slice, tile, subpicture, picture row or stripe . . . ) enclosed in an extent.
scanning_order indicates the scanning order of image portions in a grid. For instance following values are defined:
   0 (default): in raster scan order, i.e. rows and columns are organised from left-to-right and top-to-bottom starting from the top-left corner.
   1: in continuous order, i.e. starting from the top-left corner, the first row is organised from left-to-right, then the second row is organised from right-to-left, the third row is organised from left-to-right and so on.
   other values are undefined and can be used to define other scanning order if needed.
rows_minus_one is an unsigned integer that specifies the number of rows in the grid minus one.
columns_minus_one is an unsigned integer that specifies the number of columns in the grid minus one.
codec_specific_parameters is defined by the codec in use. If no such definition is available, this field is set to 0.

### Extent Configuration Using Construction Method in ItemLocationBox

In another embodiment using ItemLocationBox to describe extents constraints or extents configuration, a new contruction_method is defined, for example with value 3. With this construction_method, an item consists in multiple extents, each extent corresponding to a partition of the codec in use. In a first variant, the partition is indicated within the construction_method as follows:

When construction_method=3 (constrained extents): each extent is constrained to enclose one single image portion or partition: when the data reference points to the ‘same file’, the length of the extent is assumed to be the length (extent_length) of the data of one image portion or partition between the offset (extent_offset, if specified) or the origin (if not specified), and the end of the file; when the data reference indicates a DataEntryImdaBox or DataEntrySeqNumImdaBox, the extent_length is assumed to be the length of the data of one image portion or partition between the offset (if specified) or the origin (if not specified), and the end of the payload of the corresponding IdentifiedMediaDataBox; in all other cases, the extent_length is assumed to be the length of one image portion or partition of the referenced file between the offset (if specified) or the origin (if not specified) and the end of the file.

In a second variant, a sub-sample information item property ‘subs’ is associated to the item and the partition is the one indicated in the sub-sample information item property ‘subs’. In such case, the construction_method=3 (constrained extents) is defined similarly to construction_method=0 (file offset) with the constraint that extent enclose one single image portion or partition.

### Extent Configuration Using Flags or Version in ItemLocationBox

In another embodiment, rather than using an item property to indicate that extents are constrained to enclose an “extractable” or “independently decodable” image portion, this information can be signalled directly into the ItemLocationBox ‘iloc’. This can be done by defining a specific “flags” value or using a new version of the box or a combination of both.

If a new flags value constrained_extent_flag is defined, the ItemlocationBox may be modified as follows:

```
  Box Type: ‘iloc’
  Container: MetaBox
  Mandatory: No
  Quantity : Zero or one
  aligned(8) class ItemLocationBox extends FullBox(‘iloc’,
version, flags)
  {
  (...)
    unsigned int(16) extent_count;
    for (j=0; j<extent_count; j++) {
      if (((version == 1) ∥ (version == 2)) && (index_size
> 0)) {
        unsigned int(index_size*8) item_reference_index;
      }
      unsigned int(offset_size*8) extent_offset;
      unsigned int(length_size*8) extent_length;
    }
    if (flags & constrained_extent_flag) {
        // properties of extents (as defined in
ConstrainedExtentsProperty or ConstrainedExtentsGridProperty and
variants)
    }
  }
```

Similarly, to ConstrainedExtentsProperty or ConstrainedExtentsGridProperty and their variants of this disclosure, when the “flags” constrained_extent_flag is set, the itemLocationBox may include same fields or parameters characterizing the constrained extents.

### Extent Configuration in ItemInfoEntry

In an alternative to above embodiment, rather than using an item property or modifying the ItemLocationBox to indicate that extents are constrained to enclose an “extractable” or “independently decodable” image portion, this information can be signalled directly into the ItemInfoEntry ‘infe’ corresponding to the partitioned image item. This can be done by defining a specific “flags” value or using a new version of the box or a combination of both.

For instance, if a new flags value constrained_extent_flag is defined with a new version, the itemlocationBox may be modified as follows:

```
  Box Type: ‘infe’
  Container: ItemInfoBox
  Mandatory: No
  Quantity : Zero or more
  aligned(8) class ItemInfoEntry extends FullBox(‘infe’,
version, flags)
  (...)
  if (version >= 3)
    if (flags & constrained_extent_flag) {
      // properties of extents (as defined in
ConstrainedExtentsProperty or ConstrainedExtentsGridProperty and
variants)
    }
  }
```

Similarly, to ConstrainedExtentsProperty or ConstrainedExtentsGridProperty and their variants of this disclosure, when the “flags” constrained_extent_flag is set, the ItemInfoEntry may include same fields or parameters characterizing the constrained extents.

### Extent Configuration for Layered Images

In another embodiment, the image 300 may be encoded with a coding format supporting multiple layers N, each layer having a level M being “extractable” and “independently decodable” or “decodable with one or more layers having a level smaller or equal to M”.

The image 300 is stored as a single image item 310 with an item type representing the coding format of the image 300, for instance ‘Ihv1’ for a L-HEVC image or ‘vvc1’ for a layered VVC image. The image item 310 may be associated with at least an item property documenting the different operating points provided by the bitstream of the image item and their constitution, e.g. a OperatingPointsInformationProperty ‘oinf’ for an L-HEVC image, or a VvcOperatingPointsInformationProperty ‘vopi’ for a layered VVC image. The image item 310 may be associated with at least a TargetOlsProperty ‘tols’ (not represented) documenting the output layer set index to be provided to the decoding process, and providing the output layer set index that can be used to select which operating-point-specific information of the item property documenting the operating points applies to the image item 310.

The image item 310 may be associated with at least an ImageSpatialExtentsProperty ‘ispe’ 340 documenting the width and height of the reconstructed image in pixels. Depending on the coding format, the image item 310 may be also associated with a decoder configuration item property documenting the decoder configuration information, e.g., a VVC configuration item property ‘vvcC’ if the item type is ‘vvc1’, or a Layered HEVC configuration item property ‘IhvC’ if the item type is ‘Ihv1’.

The storage of the data of the image 310 is organized so each single extent 331, 332, 333, 334 in the item location information 335 corresponding to the image item 310 is constrained to include one single image data portion corresponding to one or more layers of the image item 300. Each extent of the associated image item in the itemLocationBox is constrained to enclose data units of one or more layers of the image item that are extractable (typically as a contiguous byte range) and independently decodable, or decodable with layer having a lower level, and renderable as an image. The storage of the data of the layers of the image 310 is organized so the data of an extent may only depend on data of a previous extent in the declaration order of the extents.

This constraint on extents or configuration of extents is indicated to the player by associating an information, for example a dedicated item property, e.g. a ConstrainedExtentsProperty ‘cdex’ 320 (or any other name or 4CC not already used by the standard) with the image item 310. When this indication is not present, a player should not assume that the image data resides in the MediaDataBox or that extents are always used to split image data into smaller coding units, such as layers.

The ConstrainedExtentsProperty may be defined as follows

```
  Box Type: ‘cdex’
  Property type: Descriptive item property
  Container: ItemPropertyContainerBox
  Mandatory (per item): No
  Quantity (per item): At most one
  aligned(8) class ConstrainedExtentsProperty extends
ItemFullProperty(‘cdex’, version = 0, flags)
  {
  }
```

The ConstrainedExtentsProperty descriptive item property indicates that each extent in the itemLocationBox associated with the item is constrained to enclose data units of the item that are “extractable” and “independently decodable” or “decodable with a previous extent in declaration order of the extents” as a unit.

A dedicated value or flag of the flags parameter is used to differentiate extents that are constrained to enclose layered data of an image from extents that are constrained to enclose partitions of an image (e.g. tiles, slices, subpictures). E.g., when the dedicated value or flag is set to a first value, it indicates that the extents of the image item are constrained to enclose layered data of an image, and when the dedicated value or flag is set to a second value, it indicates that the extents of the image item are constrained enclose partitions of an image (e.g. tiles, slices, subpictures). In a variant, instead of a dedicated value or flag of the flags parameter, a dedicated version is used to differentiate extents that are constrained to enclose layered data of an image from extents that are constrained to enclose partitions of an image (e.g. tiles, slices, subpictures).

All variants of ConstrainedExtentsProperty or ConstrainedExtentsGridProperty described above can be combined with the dedicated value or flag or the dedicated version to differentiate extents that are constrained to enclose layered data of an image from extents that are constrained to enclose partitions of an image (e.g. tiles, slices, subpictures).

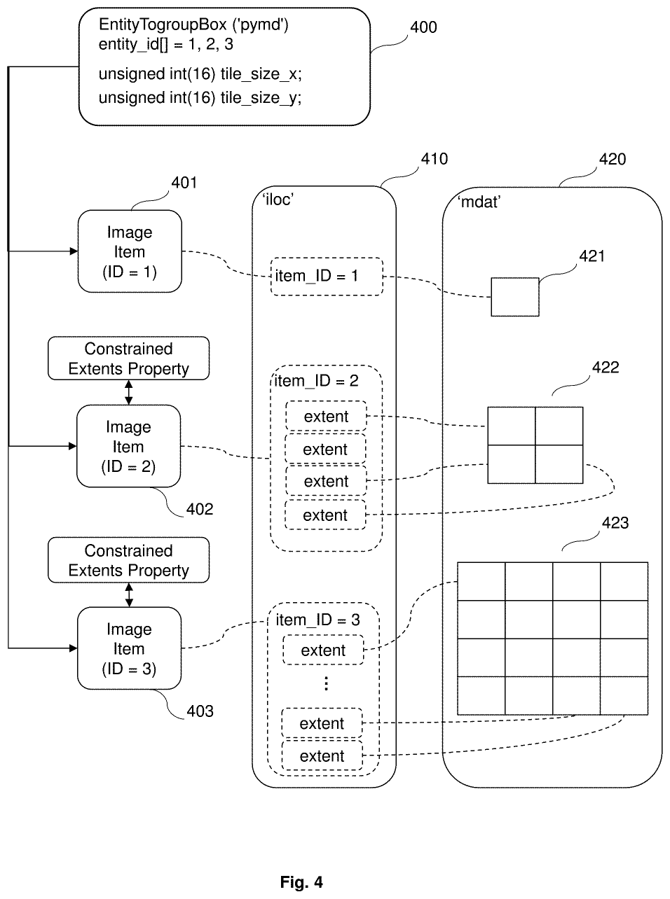

FIG. 4 illustrates a storage of multiple partitioned still image or picture in an ISOBMFF-based media file allowing to avoid downloading the complete image before displaying content or for panning across the images according to some embodiments of the disclosure.

More particularly, a pyramid of images is created from a base image 423. This base image may represent a very large resolution image. One or more intermediate images 422 and 421 are generated from the base image to ease displaying partial area of the content represented by the base image, and to allow easily zooming and panning across the image. These intermediates images are also denoted “image overviews”. An image overview may be a pre-derived coded image item (401, 402) whose reconstructed image (resp. 421, 422) was generated as a lower resolution, ‘binned’ version, of the base image 423.

In a variant, either one or more overview images or the base image are encapsulated as a grid derived image item or all the overview images and the base image are encapsulated as grid derived image items. In this variant, an image that is represented as a grid of input images is encapsulated as illustrated by reference to FIG. 2. In other words, the pyramid may mix layers encapsulated according to an embodiment of the invention and layers encapsulated according to prior art. For the sake of illustration, all the images 421, 422 and 423 are partitioned (e.g., tiled or split in subpictures) by using a feature of a specific codec or uncompressed format so each image portion or partition is “extractable” or “independently decodable”.

The overview images 421 and 422, are partitioned using the same partitioning scheme as the base image, i.e., if image portions (e.g. tiles or subpictures or any partition supported by the codec in use) in the base image are X by Y pixels, they are X by Y pixels in the overview images.

To avoid multiplying the items to describe each image portion, each partitioned image 421, 422 and 423, is stored as a single image item (resp. 401, 402, 403).

The pyramid of images 421, 422 and 423 may be described by creating an entityToGroup of type ‘pymd’ 400 that lists, for example, the images in the order of lowest resolution overview to the highest resolution overview, followed finally by the base image item.

An item property, for instance ImagePyramidInformationProperty, associated with the entityToGroup of type ‘pymd’ 400 may comprise for each of the image items belonging to the group a tile_offset and a tile_byte_count to indicate the location and size of each tile of each image item. But such item property would not be optimal for allowing easy file editing, because data offset information would not be located anymore in a single location in the file (i.e., the item location box). As a consequence, when updating the file, a writer would need to update both the item location box and the ImagePyramidInformationProperty. This would complicate a lot the process of editing. Moreover, in the cases where multiple items are used (grid derived image item, or codec-specific multiple image items), data offset information in the item property may be redundant with data offset information in the item location box.

Therefore, according to some embodiments, each partitioned image 421, 422 and 423, is stored as a single image item (resp. 401, 402, 403) and their extents are constrained so each extent encloses one single image portion, the image portion corresponding to a region in an overview image. Since the image 421, the top of the pyramid, is composed of one single image portion, there is no need to constrain the extents of the image item 401, therefore for this image item, the extents may be or may not be constrained.

Each image item is associated with an ImageSpatialExtentsProperty ‘ispe’ (not represented) providing the width and height of the reconstructed image in pixels. In some embodiments, some of the layers may be encapsulated as described in relation with FIG. 2.

The image items 402, 403 with constrained extents are associated with a constrained extents property or one of its variants or other embodiments (for instance, using modified ItemlocationBox ‘iloc’ or ItemInfoEntry ‘infe’), as illustrated by reference to FIG. 3, to signal to a player that it can rely on the extents to extract an “extractable” or “independently decodable” image portion, i.e., that extents have been constrained to enclose data units that are extractable (typically as a contiguous byte range) and independently decodable and renderable as a unit or as tiles belonging to a grid of tiles.

When all the images have the same partition scheme, the properties that are common to all images of the pyramid can be defined in the EntityToGroup of type ‘pymd’ describing the image pyramid. For instance, it may comprise the image portion size tile_size_x and tile_size_y providing the size in pixels of an image portion corresponding to a partition of the image (e.g. a tile or subpicture).

In a variant, the properties that are common to all images of the pyramid can be defined in an item property providing the overall information on the image pyramid (and possibly on its individuals tiles), for instance in an ImagePyramidInformation descriptive item property of type ‘pmdp’ associated with the EntityToGroup of type ‘pymd’.

The grid layout and the binning associated with each image in the pyramid can be computed as follows:

$$tiles\_in \_layer \_row = image\_width / tile\_size \_x ;$$

$$tiles\_in \_layer \_column = image\_height / tile\_size \_y ;$$

$$binning\_width = base\_image \text{::} image\_width / overview \text{::} image\_width$$

$$binning\_height = base\_image \text{::} image\_height / overview \text{::} image\_height$$

where
tiles_in_layer_row: Signals the number of tiles in a row.
tiles_in_layer_column: Signals the number of tiles in a column.
binning_width and binning_height Specifies the level of binning between the base image and an image overview in the pyramid.

Therefore, there is no need to store all of these values in the media file.

In an alternative, properties on the partition of images and the constraints on the extents can be defined in the constrained extents properties (or in the new ItemLocationBox or ItemInfoEntry depending on embodiments) associated with the image item as explained by reference to FIG. 3.

In a variant, rather than associating a constrained extents property with each image item, when all image items referred by an EntityToGroup of type ‘pymd’ have constrained extents, the constrained extent property can be associated with the EntityToGroup of type ‘pymd’ to inform a player that all the image items in the pyramid have constrained extents. This association may apply to other entity groups as well, as soon as the image items referenced in the entity group follow the same constraints on their extents.

In a particular embodiment, The ConstrainedExtentsProperty or ConstrainedExtentsGridProperty descriptive item property (e.g. of type ‘cexg’) indicates that each extent of the associated image item in the itemLocationBox is constrained to enclose data units of the item that are extractable (typically as a contiguous byte range) and are independently decodable and renderable as image tiles or as a unit.

All data units or properties required to configure the decoder and decode an image tile is declared in the decoder configuration and initialization properties associated with the image item.

The reconstructed image of the associated image item is formed from one or more image tiles in a given grid order within a larger canvas.

The image tiles corresponding to the extents are inserted in row-major order, top-row first, left to right, in the order of the extents for the associated image item within the ItemLocationBox. The value of extent_count within the ItemLocationBox is equal to rows*columns (or in other words, (1+rows minus one)*(1+columns_minus_one)). All image tiles have exactly the same width and height, image_tile_width and image_tile_height. The reconstructed image is formed by tiling the image tiles into a grid with a column width equal to image_tile_width and a row height equal to image_tile_height, without gap or overlap. The grid of image tiles completely “covers” the reconstructed image of the associated image item, where image_tile_width*columns is greater than or equal to image_width and image_tile_height*rows is greater than or equal to image_height, where image_width and image_height are signalled in the ImageSpatialExtentsProperty associated with the image item.

The syntax of the ConstrainedExtentsProperty or ConstrainedExtentsGridProperty descriptive item property may be as follows:

```
  Box Type: ‘cexg’
  Property type: Descriptive item property
  Container: ItemPropertyContainerBox
  Mandatory (per item or per associated item_ID): No
  Quantity (per item or per associated item_ID): At most one
  aligned(8) class ConstrainedExtentsGridProperty extends
ItemFullProperty(‘cexg’, version = 0, flags)
  {
    unsigned int FieldLength = ((flags & 1) + 1) * 16; //
this is a temporary,non-parsable variable
    unsigned int(16) rows_minus_one;
    unsigned int(16) columns_minus_one;
    unsigned int(FieldLength ) image_tile_width;
    unsigned int(FieldLength ) image_tile_height;
  }
```

where
(flags & 1) equals to 0 specifies that the length of the fields image_tile_width and image_tile_height is 16 bits. (flags & 1) equals to 1 specifies that the length of the fields image_tile_width and image_tile_height is 32 bits. The values of flags greater than 1 are reserved.
image_tile_width, image_tile_height: specify respectively the width and height in pixels of the image tiles.
rows_minus_one, columns_minus_one: specify the number of rows of image tiles, and the number of image tiles per row. The value is one less than the number of rows or columns respectively. Image tiles enclosed in extents populate the top row first, followed by the second row and following rows, in the order of extents.

Still according to this embodiment, an overview image is defined as a grid derived image item or a tiled pre-derived coded image item whose reconstructed image is formed from generating a lower resolution, ‘binned’ version of a base image item. The base image item is also a tiled image item. The tiling may be implemented using a feature of a specific codec, or by using a grid derived image item. When a grid derived image item is used, the input items to the grid define the tiles. Derived image items should not be used as inputs to the image grid, due to the need for in place byte range accessing of content. Individual tiles are written contiguously in memory, thereby allowing access with a single read or write action.

A pre-defined coded image representing an overview image or an image item representing the base image that are tiled using a feature of a specific codec is stored in such a way that each extent identifies that data range corresponding to a tile, and is associated with a ConstrainedExtentsGridProperty indicating the constraint on the extents and describing the tiling grid.

An overview image is tiled using the same tiling scheme as the base image, i.e. if tiles in the base image are X by Y pixels, they are X by Y pixels in the overview image. In cases where the binned resolution results in a fractional, or incomplete tile at the end of a row (column), the last tile in a row (column) of tiles is padded with the value zero at the end of the row (column) to complete the last tile in the row (column). If necessary, the clean aperture transformative property (‘clap’) may be applied to crop padded rows and/or columns. The number of tiles in a row (column) of tiles is determined by dividing the width (height) of the overview image by the tile size in X (tile size in Y) and rounding up.

An image pyramid is generated by stacking a series of progressively binned overview images and creating an entity group of type ‘pymd’. Each overview image is linked to or associated with the original full resolution base image, using a reference of type ‘base’ and each overview image indicates its amount of binning by its overview level. An essential property of type ‘pmdp’ carries details on the storage location of the internal tiles for the overviews and base image making up a full pyramid. This enables simple query and quick navigation and access to specific tiles of interest in the set of overviews.

The image format of the overviews is the same as the base image item. i.e. number of bands, bit depth, color format, etc.

Region items associated with the base image may be replicated for individual overviews using an appropriate scaling associated with the level of binning for a particular overview and referenced to the specific overview.

It is noted that the exact derivation process (approaches such as the sum, average, median, minimum, or maximum value of a binned region) used to produce an overview from the base image is left to the implementer.

It is also noted that when removing or modifying an item that is marked as the base image of an overview image, the content of associated image overview items might need to be rewritten.

An ImagePyramidInformation descriptive item property may provide overall information for the individual tiles inside the overview image items and base image item of an image pyramid. Image items are listed in the ordering given in the image pyramid entity group, which is from the lowest resolution overview to the base image.
essential may be equal to 1 or 0 for an ImagePyramidInformation item property.

The ImagePyramidInformation item property is associated with an image pyramid entity group.

The ImagePyramidInformation descriptive item property may have the following syntax:

```
Box Type: ‘pmdp’
Property type: Descriptive item property
Container: ItemPropertyContainerBox
Mandatory (per item or per associated item_ID): Yes, for a pyramid entity group
Quantity (per item or per associated item_ID): At most one
aligned(8) class ImagePyramidInformationProperty
extends ItemFullProperty(‘pmdp’, version = 0, flags = 0) {
  unsigned int(8) num_layers;
  unsigned int(16) tile_size_x;
  unsigned int(16) tile_size_y;
  for(i=1;i<=num_layers;i++) {
    unsigned int(8) layer_binning;
    unsigned int(16) tiles_in_layer_row_minus1;
    unsigned int(16) tiles_in_layer_column_minus1;
  }
}
```

where
num_layers: Indicates the number of overview images plus the layer for the base image. num_layers shall be equal to num_entities_in_group in the associated image pyramid entity group. The layers are ordered in the same order as in the entity group: layer value 0 is the lowest resolution.
tile_size_x, tile_size_y: indicate the size in pixels of a tile in the width and height dimension, respectively, for all levels of the pyramid.
layer_binning: Indicates for each layer of the pyramid the level of binning between the base image and the overview image. A 2×2 binning is defined to be a layer_binning of 2, a 4×4 binning is defined to be 4, etc. The width and height for an overview image with layer_binning of 2 is half the width and half the height of the base image, etc. A base image has a layer_binning of 1.
tiles_in_layer_row_minus1, tiles_in_layer_column_minus1: Indicate the number of tiles minus 1 in a row and a column, respectively, of a specific layer. If the layer is represented by a grid derived image item, tiles_in_layer_row_minus1 is equal to rows_minus1 and tiles_in_layer_column_minus1 is equal to columns_minus1. If the layer is represented by a tiled pre-derived coded image item with an ConstrainedExtentsGridProperty, then tiles_in_layer_row_minus1 is equal to rows_minus1 and tiles_in_layer_column_minus1 is equal to columns_minus1.

Still according to this embodiment, the image pyramid entity group (‘pymd’) indicates a set of entities, formed as a base image and a series of progressively binned overview images, which together form an image pyramid.

Each overview image is referenced to the original full resolution base image, using a reference of type ‘base’.

An ImagePyramidInformationProperty is associated with the image pyramid entity group, and it may be marked as essential. An essential ImagePyramidInformationProperty carries details on the set of overview images and the base image making up a full pyramid.

The image format of the overview images is the same as the base image (i.e. number of bands, bit depth, color format, etc).

This entity group comprises entity_id values that point to a base image item and a set of overview image items and comprises no entity_id values that point to tracks. The entities are listed in the order of lowest resolution overview image item to the highest resolution overview image item, followed finally by the base image item of the pyramid.

There may be multiple image pyramid entity groups in the same file with different group_id values.

It is noted that all the entities of a same image pyramid entity group, or only some of them, can also be members of a same entity group of type ‘prgr’ if they are stored in the file for allowing a progressive refinement. They can also be members of a same entity group of type ‘altr’ if they are proposed by the content creator as alternatives to be displayed for players not supporting the image pyramid entity group.

In a variant, rather than providing the parameters or details on the set of overview images and the base image making up the full pyramid in an item property associated with the image pyramid entity group ‘pymd’, the parameters or details may be declared directly inside the entity group. According to this variant, an overview image is a grid derived image item or a tiled pre-derived coded image item whose reconstructed image is formed by generating a lower resolution, ‘binned’ version of a base image item. The base image item is also a tiled image item. The tiling may be implemented using a feature of a specific codec, or by using a grid derived image item. When a grid derived image item is used, the input items to the grid define the tiles. Derived image items should not be used as inputs to the image grid, due to the need for in place byte range accessing of content. Individual tiles are written contiguously in memory, thereby allowing access with a single read or write action.

A pre-defined coded image representing an overview image or an image item representing the base image that are tiled using a feature of a specific codec is stored in such a way that each extent identifies that data range corresponding to a tile, and is associated with a ConstrainedExtentsGridProperty (or ConstrainedExtentsProperty), as described above, indicating the constraint on the extents and describing the tiling grid.

In a variant, a dedicated value or flag of the flags parameter of ConstrainedExtentsGridProperty or ConstrainedExtentsProperty (e.g. a flag is layered) is used to differentiate extents, that are constrained to enclose layered data of an image, from extents that are constrained to enclose grid partitions of an image (e.g. tiles, subpictures). E.g., when the dedicated value or flag is set to a first value, it indicates that the extents of the image item are constrained to enclose layered data of an image. In such case, the parameters image_tile_width, image_tile_height, rows_minus_one, columns_minus_one are not defined. When the dedicated value or flag is set to a second value, it indicates that the extents of the image item are constrained enclose partitions of an image (e.g. tiles, slices, subpictures).

In this variant, the syntax of the ConstrainedExtentsProperty or ConstrainedExtentsGridProperty descriptive item property may be as follows:

```
  Box Type: ‘cexg’
  Property type: Descriptive item property
  Container: ItemPropertyContainerBox
  Mandatory (per item or per associated item_ID): No
  Quantity (per item or per associated item_ID): At most one
  aligned(8) class ConstrainedExtentsProperty extends
ItemFullProperty(‘cexg’, version = 0, flags)
  {
    if (flags & islayered == 0) {
      unsigned int FieldLength = ((flags & 1) + 1) * 16;
// this is a temporary, non-parsable variable
      unsigned int(16) rows_minus_one;
        unsigned int(16) columns_minus_one;
        unsigned int(FieldLength ) image_tile_width;
        unsigned int(FieldLength ) image_tile_height;
    }
  }
```

rows_minus_one and where image_tile_width, image_tile_height, columns_minus_one are defined as described above.

An overview image shall be tiled using the same tiling scheme as the base image, i.e. if tiles in the base image are X by Y pixels, they are X by Y pixels in the overview image. In cases where the binned resolution results in a fractional, or incomplete tile at the end of a row (column), the last tile in a row (column) of tiles shall be padded with the value zero at the end of the row (column) to complete the last tile in the row (column). If necessary, the clean aperture transformative property (‘clap’) may be applied to crop padded rows and/or columns. The number of tiles in a row (column) of tiles is determined by dividing the width (height) of the overview image by the tile size in X (tile size in Y) and rounding up.

An image pyramid is generated by stacking a series of progressively binned overview images and creating an ImagePyramidEntityGroup. Each overview image is associated with the original full resolution base image, using a reference of type ‘base’. The amount of binning of each overview image is indicated in the ImagePyramidEntityGroup (also denoted EntityToGroup of type ‘pymd’ or image pyramid entity group ‘pymd’). The image format of the overviews is the same as the base image item. i.e. number of bands, bit depth, color format, etc.

Region items associated with the base image may be replicated for individual overviews using an appropriate scaling associated with the level of binning for a particular overview and referenced to the specific overview.

It is noted that the exact derivation process (approaches such as the sum, average, median, minimum, or maximum value of a binned region) used to produce an overview from the base image is left to the implementer.

It is also noted that when removing or modifying an item that is marked as the base image of an overview image, the content of associated image overview items might need to be rewritten.

Still according to this variant, the ImagePyramidEntityGroup (also denoted EntityToGroup of type ‘pymd’ or image pyramid entity group ‘pymd’) indicates a set of image items, formed as a base image item and a series of progressively binned overview image items, which together form an image pyramid.

Each overview image item has a reference to the original full resolution base image item, using a reference of type ‘base’.

The ImagePyramidEntityGroup also provides overall information for the individual tiles inside the overview image items and base image item of the image pyramid.

The image format of the overview images is the same as the base image (i.e. number of bands, bit depth, color format, etc).

This entity group comprises entity_id values that point to a base image item and a set of overview image items and comprises no entity_id values that point to tracks. The entities are listed in the order of lowest resolution overview image item to the highest resolution overview image item, followed finally by the base image item of the image pyramid.

There may be multiple ImagePyramidEntityGroup in the same file with different group_id values.

It is noted that all the entities of a same ImagePyramidEntityGroup, or only some of them, can also be members of a same entity group of type ‘prgr’ if they are stored in the file for allowing a progressive refinement. They can also be members of a same entity group of type ‘altr’ if they are proposed by the content creator as alternatives to be displayed for players not supporting the ImagePyramidEntityGroup.

The ImagePyramidEntityGroup may have the following syntax:

```
Box Type: ‘pymd’
Container: GroupListBox in a MetaBox at file level
Mandatory: No
Quantity: Zero or more
aligned(8) class ImagePyramidEntityGroup
extends EntityToGroupBox (‘pymd’, version = 0, flags = 0) {
  unsigned int(16) tile_size_x;
  unsigned int(16) tile_size_y;
  for (i=0; i<num_entities_in_group;i++) {
    unsigned int(8) layer_binning;
    unsigned int(16) tiles_in_layer_row_minus1;
    unsigned int(16) tiles_in_layer_column _minus1;
  }
}
```

where
num_entities_in_group is as defined for EntityToGroupBox. In addition, it also specifies the number of layers of the image pyramid.
tile_size_x, tile_size_y: indicate the size in pixels of a tile in the width and height dimension, respectively, for all layers of the image pyramid.
layer binning: Indicates for each layer of the pyramid the level of binning between the base image and the overview image. A 2×2 binning is defined to be a layer_binning of 2, a 4×4 binning is defined to be 4, etc. The width and height for an overview image with layer_binning of 2 is half the width and half the height of the base image, etc. A base image has a layer binning of 1.
tiles_in_layer_row_minus1, tiles_in_layer_column_minus1: Indicate the number of tiles minus one in a row and a column, respectively, of a specific layer. If the layer is represented by a grid derived image item, tiles_in_layer_row_minus1 is equal to rows_minus_one and tiles_in_layer_column_minus1 is equal to columns_minus_one. If the layer is represented by a tiled pre-derived coded image item with an ConstrainedExtentsGridProperty, then tiles_in_layer_row_minus1 is equal to rows_minus_one and tiles_in_layer_column_minus1 is equal to columns_minus_one.

In a variant, the parameters layer_binning, tiles_in_layer_row_minus1 and tiles_in_layer_column_minus1 may be optional and the grid layout and the binning associated with each image in the pyramid may be inferred as described by reference to FIG. 4.

In another variant, the ImagePyramidEntityGroup may have the following syntax:

Box Type: ‘pymd’
Container: GroupListBox in a MetaBox at file level
Mandatory: No
Quantity: Zero or more
aligned(8) class ImagePyramidEntityGroup
extends EntityToGroupBox (‘pymd’, version = 0, flags) {
}

where all the parameters characterizing an image of the image pyramid, overview or base image, and its partitioning, e.g. layer_binning, tiles_in_layer_row_minus1, tiles_in_layer_column_minus1, tile_size_x, and tile_size_y, are inferred as follows:
layer_binning=base width/overview width, or base height/overview height, where the division may be either an integer or float division.
tiles_in_layer_row_minus1 and tiles_in_layer_column_minus1 may be inferred from the rows_minus_one and columns_minus_one parameters of a grid derived image item, when the image is described by a grid derived image item, or from num_tile_rows_minus_one and num_tile_cols_minus_one parameters of a UncompressedFrameConfigBox ‘uncC’ box when the image is described by an uncompressed image item. They may also be inferred from partitioning parameters of a parameter set when the image is described by an image item with an item_type corresponding to a compressed or encoded image, e.g. from sps_subpic_width_minus1 and sps_subpic_height_minus1 for a VVC-coded image, or from column_width_minus1 and row_height_minus1 for an HEVC-coded image.
tile_size_x=image_width from the ‘ispe’ item property associated with the overview divided by tiles_in_layer_column_minus1+1.
tile_size_y=image_height from the ‘ispe’ item property associated with the overview divided by tiles_in_layer_row_minus1+1.

These parameters may be obtained from a decoder configuration property (e.g. ‘hvcC’, ‘vvcC’) that embed the encoding parameter sets.

In a variant, above parameters or part of above parameters may be explicitly defined in the ImagePyramidEntityGroup or inferred depending on a predefined value of the flags or version parameter.

For instance, it may be useful to define explicitly the tile size (e.g. tile_size_x, tile_size_y) when this tile size cannot be directly deduced from the information of the ‘ispe’ item property (comprising image_width, image_height) associated with the image, in particular when the column width and row height are not constant for all columns or rows.

In another variant, each image, overview or base image, in an image pyramid may have a regular partitioning scheme, i.e. all tile columns have the same width and all tile rows have the same height, possibly except for the rightmost column and bottommost row that may be smaller, and with different tile sizes in each level. The ImagePyramidEntityGroup may comprise an indication for signalling whether the tile size is the same or may be different between each level, e.g. by using a predefined value of the flags or version parameter of the EntityToGroupBox or an additional parameter in the payload of the ImagePyramidEntityGroup.

For instance, the ImagePyramidEntityGroup may have the following syntax:

```
  Box Type: ‘pymd’
  Container: GroupListBox in a MetaBox at file level
  Mandatory: No
  Quantity: Zero or more
  aligned(8) class ImagePyramidEntityGroup
  extends EntityToGroupBox (‘pymd’, version = 0, flags) {
    if ((flags & same_tile_size) && (flags &
tile_size_present) {
      unsigned int(16) tile_size_x;
      unsigned int(16) tile_size_y;
    }
    for (i=0; i<num_entities_in_group;i++) {
      if ((flags & same_tile_size == 0) && (flags &
tile_size_present) {
        unsigned int(16) tile_size_x;
        unsigned int(16) tile_size_y;
      }
      if (flags & layer_binning present)
        unsigned int(16) layer_binning;
      if (flags & layer_row_column_present) {
        unsigned int(16) tiles_in_layer_row_minus1;
        unsigned int(16) tiles_in_layer_column_minus1;
      }
    }
  }
```

where followings flags values are defined:
0x001000, same tile size; when set, it specifies that the tiles have the same tile size in each level. When not set, it specifies that the tiles may have different tile size in each level.
0x002000, tile size present; when set, it specifies that the fields tile_size_x and tile_size_y are present. When not set, it specifies that the fields tile_size_x and tile_size_y are not present and are inferred.
0x004000, layer binning present; when set, it specifies that the fields layer_binning is present. When not set, it specifies that the fields layer_binning is not present and is inferred.
0x008000, layer row column present; when set, it specifies that the fields tiles_in_layer_row_minus1 and tiles_in_layer_column_minus1 are present. When not set, it specifies that the fields tiles_in_layer_row_minus1 and tiles_in_layer_column_minus1 are not present and are inferred.

When present, the semantics of following fields tile_size_x, tile_size_y, layer_binning, tiles_in_layer_row_minus1 and tiles_in_layer_column_minus1 are defined as previously described above. When not present, the following fields tile_size_x, tile_size_y, layer_binning, tiles_in_layer_row_minus1 and tiles_in_layer_column_minus1 may be inferred as previously described above.

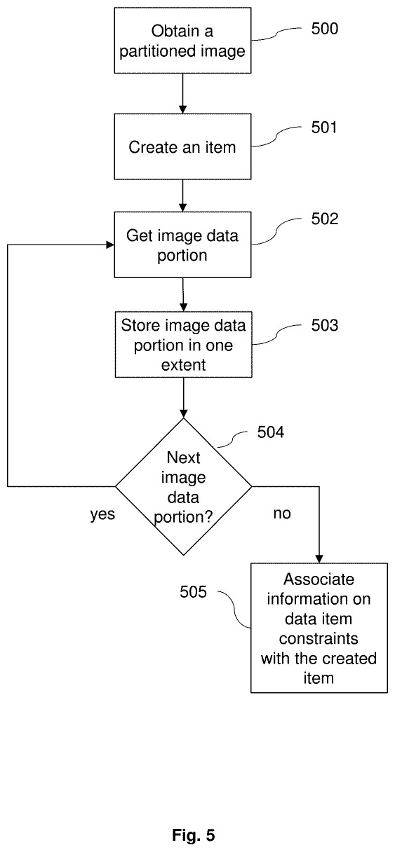

FIG. 5 illustrates the main steps of a process for encapsulating partitioned images according to embodiments of the invention.

In a step 500 a partitioned image is obtained. The image may be uncompressed according to a raw format like, for example, RGB, YUV, or compressed according to a compression format like, for example, JPEG, HEVC or VVC. The image is partitioned according to a regular, or non regular, grid of rectangular portions. When the image is compressed, the compressions format is assumed to support “extractable” or “independently decodable” image portions.

In a step 501, a single image item is generated for encapsulating the partitioned image with an item type corresponding to the coding format or uncompressed format of the image.

Then a loop on the image partitions is executed corresponding to steps 502, 503 and 504. For each image portion, the image data portion is stored in the media data referenced by a corresponding extent associated with the image item and stored in the ItemLocationBox ‘iloc’.

In a step 505, an information indicating that each extent of the image item is constrained to enclose data units of the image item that are extractable and independently decodable (for instance as a unit) is generated. This information is associated with the image item. According to embodiments, the information may correspond to a dedicated item property associated with the image item, or in the ItemLocationBox in the part, i.e., the item location information, associated with the image item, or the ItemInfoEntry associated with the image item.

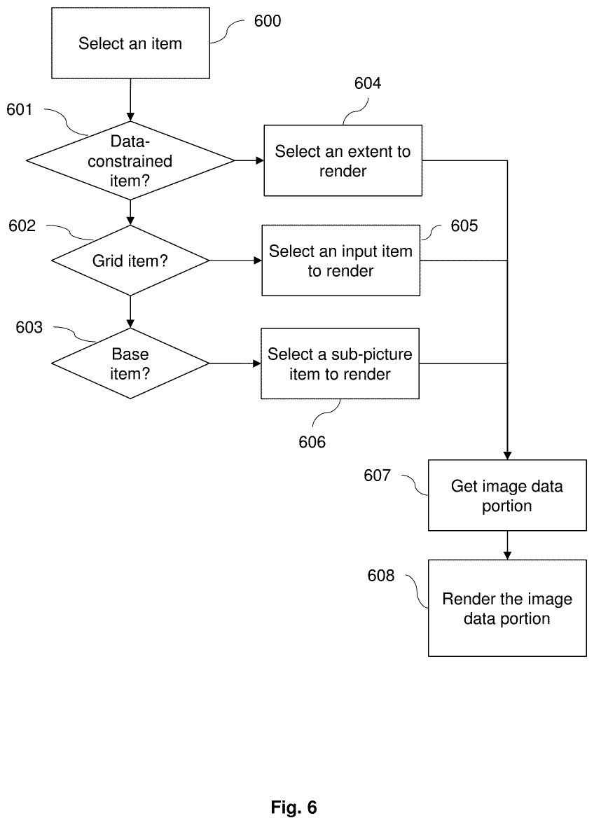

FIG. 6 illustrates the main steps of a process for parsing a media file comprising a partitioned image possibly encapsulated according to embodiments of the invention and rendering an image portion of the partitioned image.

In a step 600, the image items associated with the partitioned image is selected. In a step 601, the presence of an information indicating that each extent of the image item is constrained to enclose data units of the image item that are extractable and independently decodable (for instance as a unit) is checked. As a reminder, according to embodiments, the information may be a dedicated item property associated with the image item or be located in the ItemLocationBox or the ItemInfoEntry. When this information is present it means that the partitioned image is encapsulated according to embodiments of the invention. Accordingly, each of the image data portions is encapsulated as one single extent associated with the image item, and one of these extents is selected in a step 604 for rendering.

When no information indicating that each extent of the image item is constrained to enclose data units of the image item that are extractable and independently decodable (for instance as a unit) is found, it is tested in a step 602 if the image item corresponds to a grid image item. When this is the case, it means that the partitioned image is encapsulated as a grid derived image item as illustrated by FIG. 2. Accordingly, one of the input image items corresponding to one of the image portion is selected for rendering in a step 605.

When the image item is not a grid derived item, it is tested if the image item is a base image item in a step 603. When this is the case, it means that the image portions correspond to subpictures or tiles encapsulated into subpicture image items or tile image items associated with the base image item as also illustrated by FIG. 2. Accordingly, one of the subpicture image items or tile image items corresponding to one of the image portion is selected for rendering in a step 606.

Steps 604, 605 and 606 are followed by a step 607 where the image data portion is extracted from the media data. The location of these data is determined according to information in the ItemLocationBox, either as a single extent, or associated with the input image item or the subpicture image item.

In a step 608, the image data portion extracted in step 607 is decoded, if needed, and is processed by the player, for instance, for rendering.

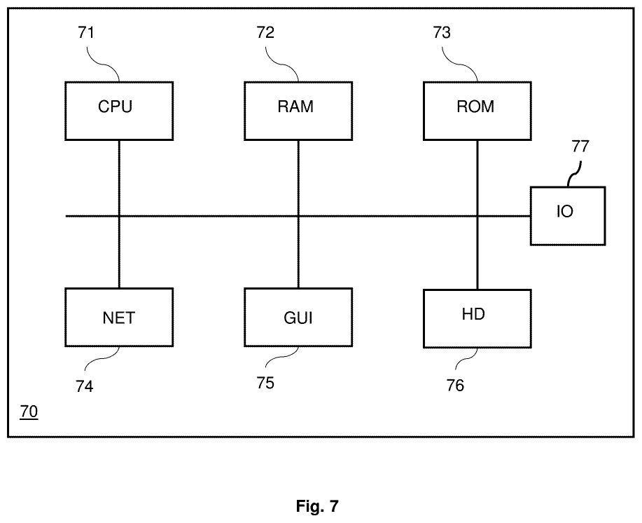

FIG. 7 is a schematic block diagram of a computing device 70 for implementation of one or more embodiments of the invention. The computing device 70 may be a device such as a microcomputer, a workstation or a light portable device. The computing device 70 comprises a communication bus connected to:
a central processing unit 71, such as a microprocessor, denoted CPU;
a random access memory 72, denoted RAM, for storing the executable code of the method of embodiments of the invention as well as the registers adapted to record variables and parameters necessary for implementing the method according to embodiments of the invention, the memory capacity thereof can be expanded by an optional RAM connected to an expansion port, for example;
a read-only memory 73, denoted ROM, for storing computer programs for implementing embodiments of the invention;
a network interface 74 is typically connected to a communication network over which digital data to be processed are transmitted or received. The network interface 74 can be a single network interface, or composed of a set of different network interfaces (for instance wired and wireless interfaces, or different kinds of wired or wireless interfaces). Data packets are written to the network interface for transmission or are read from the network interface for reception under the control of the software application running in the CPU 71;
a user interface 75 may be used for receiving inputs from a user or to display information to a user;
a hard disk 76 denoted HD may be provided as a mass storage device;
an I/O module 77 may be used for receiving/sending data from/to external devices such as a video source or display.

The executable code may be stored either in read only memory 73, on the hard disk 76 or on a removable digital medium such as for example a disk. According to a variant, the executable code of the programs can be received by means of a communication network, via the network interface 74, in order to be stored in one of the storage means of the communication device 70, such as the hard disk 76, before being executed.

The central processing unit 71 is adapted to control and direct the execution of the instructions or portions of software code of the program or programs according to embodiments of the invention, which instructions are stored in one of the aforementioned storage means. After powering on, the CPU 71 is capable of executing instructions from main RAM memory 72 relating to a software application after those instructions have been loaded from the program ROM 73 or the hard disk (HD) 76 for example. Such a software application, when executed by the CPU 71, causes the steps of the flowcharts of the invention to be performed.

Any step of the algorithms of the invention may be implemented in software by execution of a set of instructions or program by a programmable computing machine, such as a PC (“Personal Computer”), a DSP (“Digital Signal Processor”) or a microcontroller; or else implemented in hardware by a machine or a dedicated component, such as an FPGA (“Field-Programmable Gate Array”) or an ASIC (“Application-Specific Integrated Circuit”).

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

Each of the embodiments of the invention described above can be implemented solely or as a combination of a plurality of the embodiments. Also, features from different embodiments can be combined where necessary or where the combination of elements or features from individual embodiments in a single embodiment is beneficial.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of encapsulation of a partitioned image in an ISOBMFF based media file, the image being partitioned in rectangular image portions, the image portions being independently decodable, the method comprising the following steps:
obtaining the partitioned image;
generating an image item describing the partitioned image;
storing each image portion data in a different extent of the image item;
associating information with the image item, the information indicating that each extent of the image item is constrained to enclose data units of the image item that are extractable and independently decodable; and
encapsulating the image item, the associated information and the partitioned image.

2. The method of claim 1, wherein the information is a dedicated item property associated with the image item.

3. The method of claim 1, wherein the image portions are organized in a grid in raster scan order.

4. The method of claim 1, wherein all image portions having the same size, the size in pixels of an image portion is determined from information described in a decoder configuration information box and/or from information in an item property associated with the image item.

5. The method of claim 1, wherein the information is stored in an ItemLocationBox of the media file.

6. The method of claim 2- or 5, wherein the information comprises optional parameters for describing properties of the image portions.

7. The method of claim 1, wherein the method further comprises:
generating a pyramid of partitioned overview images from the partitioned image, each partitioned overview image being a lower resolution version of the partitioned image;
encapsulating at least one of the partitioned overview images;
generating an entity ToGroup grouping the partitioned image and the overview images; and
encapsulating the entity ToGroup in the media file.

8. The method of claim 7, wherein all the partitioned overview images are encapsulated.

9. The method of claim 7, wherein the information is stored in the entityToGroup.

10. A method of rendering an image portion of a partitioned image encapsulated in an ISOBMFF based media file, the method comprising:
obtaining from the media file an image item describing the partitioned image;
obtaining from the media file information associated with the image item, the information indicating that each extent of the image item is constrained to enclose data units of the image item that are extractable and independently decodable;
selecting an extent of the image item;
extracting the image data portion enclosed in the extent and
rendering an image portion using the extracted image data portion.

11. The method of claim 10, wherein the information is obtained from a dedicated item property associated with the image item.

12. The method of claim 10, wherein the image portions are organized in a grid in raster scan order.

13. The method of claim 10, wherein all image portions having the same size, the size in pixels of an image portion is determined from information described in a decoder configuration information box and/or from information in an item property associated with the image item in the media file.

14. The method of claim 10, wherein the information is obtained from an ItemLocationBox of the media file.

15. The method of claim 11, wherein the information comprises optional parameters for describing properties of the image portion.

16. The method of claim 10, wherein the method further comprises:
obtaining from the media file an entity ToGroup grouping the partitioned image and partitioned overview images forming a pyramid of partitioned overview images, each partitioned overview image being a lower resolution version of the partitioned image;
rendering an image portion of a partitioned overview image.

17. (canceled)

18. A non-transitory computer-readable storage medium storing instructions of a computer program for implementing a method according to claim 1.

19. (canceled)

20. A processing device comprising a processing unit configured for carrying out each step of the method according to claim 1.

21. A non-transitory computer-readable storage medium storing instructions of a computer program for implementing a method according to claim 16.
